(19) United States
(12) Patent Application Publication
(10) Pub. No.: US 2005/0232746 A1
(43) Pub. Date: Oct. 20, 2005

(54) Device for the automatic formation of packs of panels of electro-welded mesh and relative method

(75) Inventor: Ermanno Taboga, Buia (IT)

Correspondence Address: STEVENS DAVIS MILLER & MOSHER, LLP, 1615 L STREET, NW, SUITE 850, WASHINGTON, DC, 20036, US

(73) Assignee: Beta Systems Srl, Reana del Rojale (IT)

(21) Appl. No.: 10/520,135

(22) PCT Filed: Jul. 14, 2003
(86) PCT No.: PCT/IB03/02789

§ 371 Date: Jan. 3, 2005

(30) Foreign Application Priority Data
Jul. 15, 2002 (IT) US2002A000158

(51) Int. Cl. H01M 4/38

(52) U.S. Cl. 414/765

(57) ABSTRACT

Device and method for the automatic formation of packs of panels of electro-welded mesh. The device is arranged downstream of a production machine provided with a work plane. The device is provided with an expulsion element which arranges the panels emerging from the machine onto an accumulation plane located as an extension to the work plane of the machine, a turnover device which turns over every other panel with respect to the position in which it exits the machine, and a discharge device to discharge the panels. The device also comprises a switching device arranged downstream of the expulsion device in order to direct alternately, and substantially continuously, at least one panel either directly towards the accumulation plane or towards the turnover device.

### FIELD OF THE INVENTION

The present invention concerns a device for the automatic formation of packs of panels of electro-welded metal mesh, used for reinforcement in concrete structural elements.

The device according to the invention is located downstream of a machine producing mesh, in particular downstream of the shearing means which shear the panels made by the machine to size. The device comprises switching means able to direct, under normal working conditions, every other panel produced by the machine towards turnover means which rotate said panel through 180° and position it overturned on discharge means. The discharge means are able to receive and to discharge, alternately and substantially continuously, a first straight panel and a second overturned panel so as to achieve packs of superimposed panels occupying a minimal space in thickness.

The invention also concerns the method to automatically form packs of panels of electro-welded metal mesh.

### BACKGROUND OF THE INVENTION

In processes for storing and discharging electro-welded mesh in the form of sheared-to-size panels, the technique is known of turning over every other panel so that, when the two panels are superimposed, the relative transverse wires are reciprocally intercalated, thus considerably reducing the space occupied in thickness of the pile formed.

One known device which overturns the panels of mesh uses grippers which pick up a panel from an accumulation plane located downstream of the production machine, rotate it through 180° with respect to the position in which it has exited from the machine and subsequently reposition it on the same plane, superimposing it on the subsequent panel produced by the machine.

This operation, however, causes downtimes, or at least slowdowns in the production cycle, since the grippers, picking up the panel, do not allow to instantaneously free the accumulation plane in order to receive the new panel produced by the machine. This disadvantage is a particular problem in the production of small size panels, for example between 3 and 6 metres, and when the machine is of the high productivity type, for example suitable to reach speeds of up to 240 transverse wires welded every minute.

A further disadvantage of conventional machines is that the supporting means provided on the accumulation plane, on which the pack of superimposed panels is formed, and which are then driven to discharge the pack onto a storage surface below, normally consist of angular profiles, for example L-shaped. When such profiles rotate to make the panels fall onto the underlying surface, they must then be repositioned with an inverse rotation in order to be ready for the next cycle; this causes further waiting times for the machine producing the mesh.

Applicant has devised and embodied the present invention to overcome these shortcomings of the state of the art and to obtain further advantages.

### SUMMARY OF THE INVENTION

The present invention is set forth and characterized in the main claims, while the dependent claims describe other innovative characteristics of the invention.

One purpose of the present invention is to achieve a device for the automatic formation of packs of panels of electro-welded mesh suitable to reduce the waiting times caused by the process of turning over every other panel, placing them one above the other and discharging them, allowing a substantially continuous production without intervals even in machines with high and extremely high productivity.

The device according to the invention is arranged downstream of a machine to produce panels of electro-welded mesh, in particular downstream of shearing means which shear said panels to a desired size. The device comprises expulsion means, associated with the shearing means, to arrange the panels emerging from the machine onto an accumulation plane located substantially as an extension of the work plane of the production machine, turnover means able to overturn at least every other one of said panels with respect to their position as they exit the machine, so as to allow them to be superimposed, with panels which have not been overturned, with the relative transverse wires intercalated with each other, and discharge means to discharge the panels onto an underlying storage surface.

According to one characteristic of the present invention, the device comprises switching means arranged downstream of the shearing means and able to direct, alternately and substantially continuously, every other panel emerging from the production machine, and as prepared by the shearing means, either towards the accumulation plane or towards the turnover means.

In a preferential form of embodiment, the switching means comprise a pivoting selector movable between a first position wherein it directs a first panel towards the accumulation plane, and a second position wherein it directs a second panel, subsequent and/or previous to the first, towards the turnover means.

The turnover means, in a preferential embodiment, comprise guide means conformed so as to rotate the panel to be overturned substantially through 180° and to position it overturned with respect to and above the accumulation plane.

In a preferential embodiment, the guide means comprise at least a first segment conformed as an inclined plane and at least a second curved segment which connects the inclined plane segment to the accumulation plane and determines the rotation through 180° of the panel to be overturned.

On the accumulation plane there are supporting means able to be selectively driven to alternately discharge one panel linearly as it emerges from the machine, and one overturned panel, onto an underlying storage surface, so as to form packs of panels having the corresponding transverse wires intercalated.

According to another characteristic of the present invention, the supporting means comprise at least two rotary elements, cooperating with respective opposite sides of the panel and each having a configuration with blades, advantageously cross-wise; the rotary elements are able to selectively rotate in order to make the panels fall and be discharged. In this way, every time the rotary elements are activated, at least one panel, alternately straight or overturned, is discharged onto the underlying surface but, due to their blade-like conformation, the supporting means are already ready, without needing to be repositioned, to receive another panel, overturned or straight, produced in the subsequent cycle.

According to a variant, first guide means are provided, arranged substantially in axis with the outlet of the turnover means, and second guide means substantially aligned with the outlet of the production machine, parallel to and underneath the first guide means. The first guide means serve to receive and position an overturned panel above a second straight panel emerging from the machine and arranged on second guide means. Both the first and the second guide means advantageously consist of supporting means configured as rotary blades as described above.

The present invention also concerns a method for the automatic formation of packs of panels of electro-welded mesh.

The method comprises the alternate and continuous dispatch, performed by switching means, of every other panel emerging from the production machine, towards turnover means, and the alternate and substantially continuous discharge of the panels, or the packs of two panels, so as to position them superimposed on an underlying storage surface.

With the present invention it is possible to overturn alternately at least every other panel without having to temporarily interrupt the production of the panels, since the switching means arranged at outlet from the production machine and upstream of the accumulation plane allow to overturn every other panel and instantaneously free the accumulation plane in order to receive the subsequent panel. Moreover, the supporting and discharge means, having a blade-type conformation, advantageously cross-wise, do not require any repositioning time, so that production can take place substantially continuously.

These advantages lead to a considerable reduction, or even cancellation, of the waiting times of the production machine, thus considerably increasing productivity.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a side view of the device for the formation of packs of panels of electro-welded mesh according to the present invention;

FIG. 2 is a schematic view from behind of the device in FIG. 1;

FIGS. 3-11 show the functioning cycle of the device in FIG. 1.

### DETAILED DESCRIPTION OF A PREFERENTIAL FORM OF EMBODIMENT OF THE INVENTION

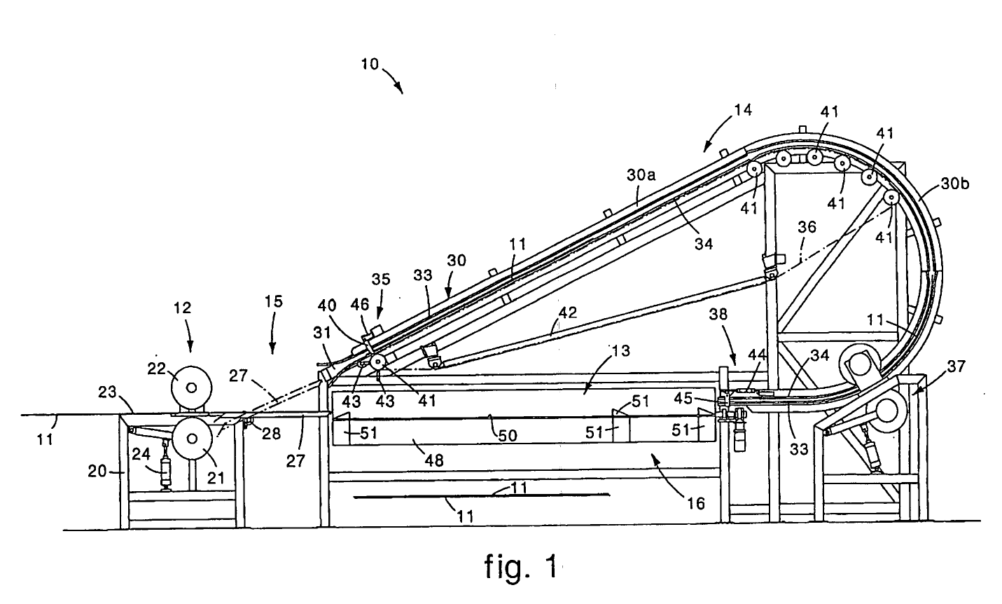

With reference to FIG. 1, a device 10 for the formation of packs of panels 11 of electro-welded mesh comprises expulsion means 12, an accumulation plane 13, a turnover mechanism 14, switching means consisting of a selector 15, and discharge means 16. The panels 11 are of the conventional type and include a plurality of longitudinal metal wires on which are welded, normally at a constant pitch, a plurality of transverse metal wires, in order to form a mesh.

The panels 11 are produced by a production machine, of a conventional type and not shown in the drawings, arranged upstream of the device 10 and equipped at outlet with shearing means able to produce panels of a desired size.

The device 10 is applied particularly, but not exclusively, to machines for the production of small size panels 11, for example between 3 and 6 metres, and high and extremely high productivity, suitable to achieve up to 240 strokes a minute, that is, 240 transverse wires welded every minute. Such a machine is able to produce a panel 11 about 3 metres long every 4 seconds.

The expulsion means 12 are arranged downstream of the shearing means (not shown here) of the machine, and comprise a pair of selectively driven rollers, a lower roller 21 and an upper roller 22, mounted on a frame 20 defining a plane of feed 23 for the panels 11. The rollers 21 and 22 are arranged opposite each other with respect to the plane of feed 23; the lower roller 21 is selectively movable, by means of a linear actuator 24, from an inactive position wherein it is detached from the panel 11, to an active position wherein it is taken into contact with the panel 11, causing it to advance.

The selector element 15 is arranged downstream of the expulsion means 12, and comprises a pivoting board 27 movable, by means of a corresponding actuator which is not shown here, between a first lowered position wherein it directs a first panel 11 towards the accumulation plane 13 arranged as a substantial extension of the plane of feed 23, and a second raised position wherein it directs a second panel 11 towards the turnover mechanism 14. The board 27 is hinged to the frame 20 of the expulsion means 12 on a rotation axis 28.

The panels 11, which will be discharged later, are positioned on the accumulation plane 13.

The turnover mechanism 14 consists in this case of a guide 30 defining a turnover path comprising a first inclined rectilinear segment 30a and a second curved segment 30b connecting the first segment 30a and the accumulation plane 13.

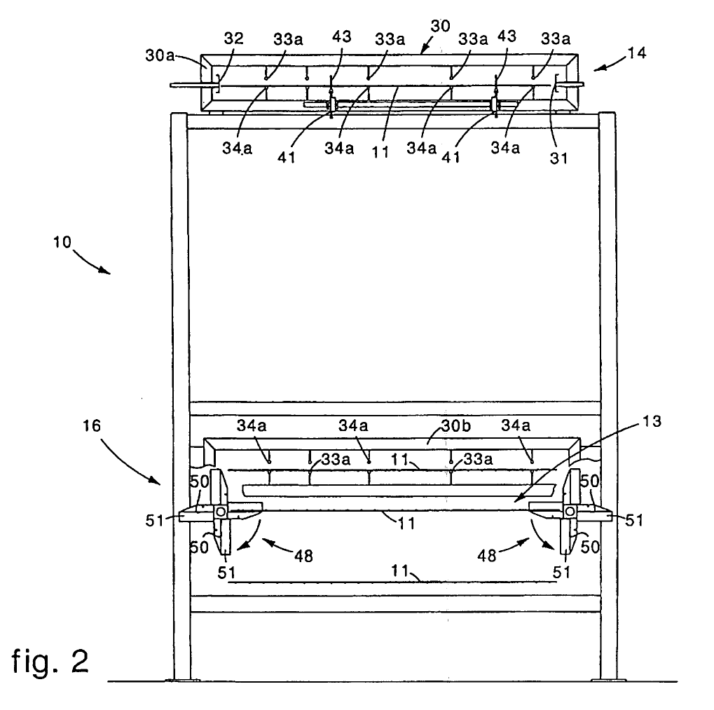

The guide 30 comprises two lateral containing blades 31 and 32 (FIGS. 1 and 2) arranged along its whole profile, and two equidistant supporting surfaces, first 33 and second 34. The surfaces 33, 34 are formed by a plurality of bars 33a and 34a, arranged parallel with each other, transverse to the axis on which the panels 11 advance, and are shaped so as to define the first segment 30a and the second segment 30b.

The turnover mechanism 14 also comprises attachment means 35, a movement chain 36, second expulsion means 37 and a clamping block 38. The attachment means 35 are arranged in an initial zone of the first segment 30a, and comprise a tooth 40 hinged on the guide 30, and able to rotate only in the direction of feed of the panel 11. The tooth 40 is normally kept in the lowered position by an elastic element 46, in order to interfere with the passage of the panel 11.

The movement chain 36, indicated schematically with a line of dots and dashes, is arranged around a plurality of pulleys 41, so as to present one useable segment arranged below the guide 30. The chain 36 has a plurality of sliders 43, attached perpendicularly to its links, and able to move the panels 11 inside the guide 30, at least along the first segment 30a and part of the second segment 30b. The chain 30 is kept under tension by a tenser 42 of a conventional type and therefore not described in any detail here.

The second expulsion means 37 are arranged in proximity with a terminal zone of the second segment 30b, and are able to take the panel 11 outside the guide means 30, and position it overturned on the accumulation plane 13.

Downstream of the second expulsion means 37 the clamping block 38 is positioned, provided with a linear actuator 44 able to act on a lever 45 in order to free the passage at outlet from the second segment 30b of the guide 30.

The discharge means 16 are arranged in correspondence with the accumulation plane 13 and comprise, in this case, two rotary elements 48 arranged opposite each other in order to cooperate with two opposite sides of the panels 11. The rotary elements 48, as shown in FIG. 2, have a substantially cross-type transverse section, and can selectively rotate on their own axis in order to cause the discharge of the panels 11 onto an underlying storage surface.

To be more exact, due to its cross-type conformation, every rotary element 48 comprises four supporting surfaces 50, each one able to support a panel 11 emerging directly from the production machine or after having been overturned along the guide 30. Rotating through 90° in the directions indicated by the arrows in FIG. 2, the rotary elements 48 cause the panel 11 to fall onto the underlying surface and, at the same time, are already automatically prepared to receive the next panel 11, on two other supporting surfaces 50.

Moreover, on each of the supporting surfaces 50, there are abutment blocks 51, positioned at appropriate distances according to the size of the panels 11 formed by the machine. Thanks to the blocks 51 it is possible to position the obtained panels 11 automatically and correctly, without needing to intervene afterwards. According to a variant, not shown in the drawings, below the discharge means 16 there is a packing device and a conveyor belt which prepare and transport packs of panels 11 of the desired number.

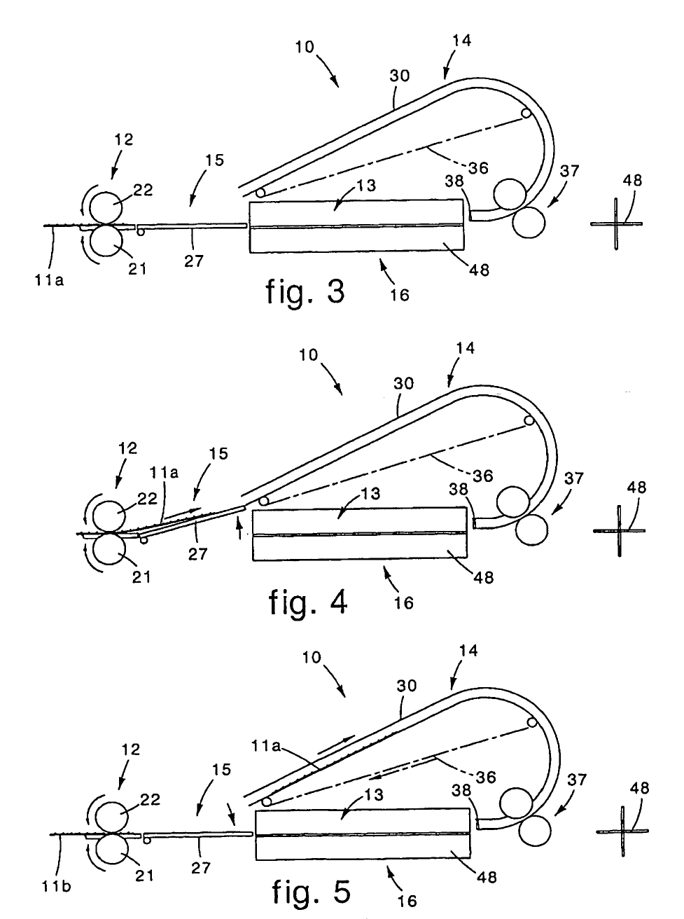

FIGS. 3 to 11 show some steps in the cycle of the device 10 as described heretofore. In order to facilitate comprehension of the description, the panels 11 introduced will be indicated by the numbers 11a, 11b, 11c, . . . and so on, according to the order they are introduced into the device 10. It must be understood that the structural characteristics of the various panels 11a, 11b, 11c, . . . are identical and remain as described heretofore.

When a first panel 11a is introduced, the linear actuator 24 of the expulsion means 12 takes the lower roller 21 into contact with said panel 11a (FIG. 3), while the roller 22 is still in rotation. In this way, driving the lower roller 21 causes the panel 11a to move forwards along the plane 23. The pivoting board 27 of the selector element 15 is rotated so as to direct the panel 11a towards the guide 30 (FIG. 4), while the expulsion means 12 continue to make the panel 11a advance.

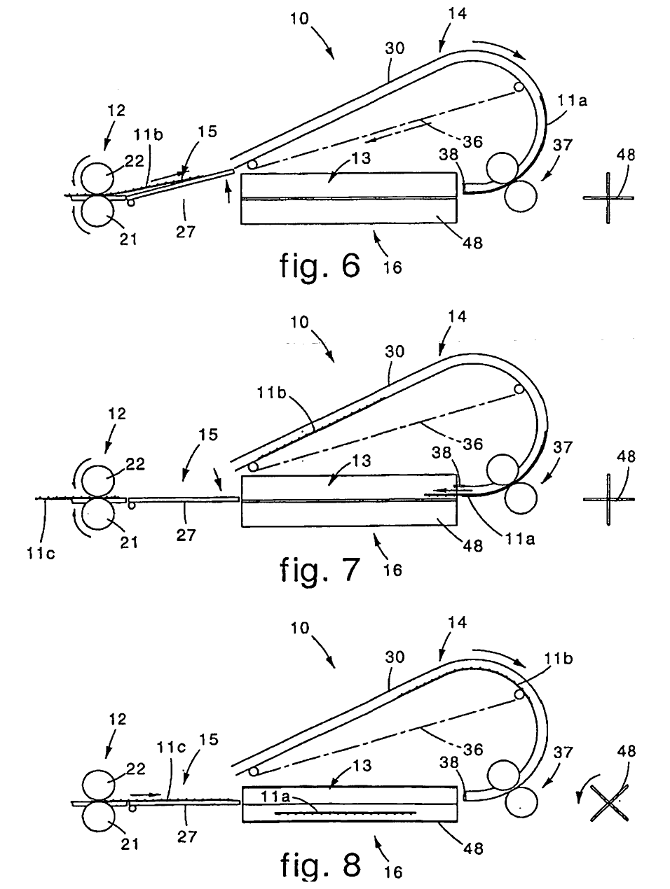

Once it has entered the guide 30 (FIG. 5), the panel 11a is moved by the chain 36 by means of the sliders 43. While the first panel 11a is moved by the chain 36, until it is taken to the second segment 30b of the guide 30 and stopped here by the clamping block 38 (FIG. 6), a second panel 11b produced afterwards by the machine is sent to the device 10.

A preferential embodiment provides that the second panel 11b is also sent to the turnover mechanism 14, so as to form a constant supply of at least one panel 11 already positioned inside the guide 30. According to the size of the panels 11, the speed of production of the machine, and the length of the guide 30, on each occasion a number of panels 11 will be provided such as can be inserted in the turnover mechanism 14 at the start of the cycle to function as a supply.

When the chain 36 is gripping on the second panel 11b (FIG. 7), the lever 45 of the clamping block 38 is lifted and the second expulsion means 37 make the first panel 11a progressively advance towards the accumulation plane 13, while a third panel 11c is produced by the machine and introduced into the device 10.

During this step, the board 27 has returned to the substantially horizontal position aligned with the work plane of the machine.

As it passes inside the guide 30, the panel 11a passes from contact with the first supporting surface 33, in the first segment 30a and in part of the second segment 30b, into contact with the surface 34, in the terminal part of the second segment 30b, thus exiting from the guide 30 overturned by 180° with respect to the position in which it exited the production machine.

At this point the rotary elements 48 are made to rotate through 90°, causing the panel 11a to fall onto an underlying storage surface (FIG. 8). According to a variant, not shown here, a first straight panel is pre-positioned on said storage surface, so that the overturned panel 11a is superimposed on said straight panel, with the corresponding transverse wires intercalated.

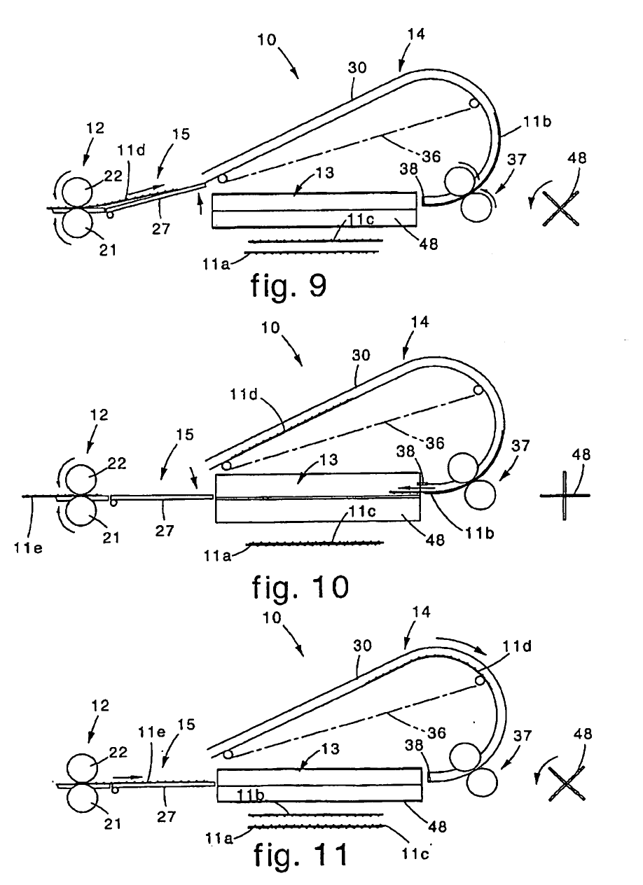

As we have said, the machine simultaneously produces a third panel 11c which is directed, by positioning the pivoting board 27 in the second, lowered position, towards the accumulation plane 13. In FIG. 9, the second panel 11b is made to advance until it is in contact with the clamping block 38, and a fourth panel 11d is thrust by the expulsion means 12 and directed by the pivoting board 27, taken to the first raised position, towards the guide 30.

The panel 11c rests on the rotary elements 48, whose transverse section is shown schematically on the right of the corresponding figures from 3 to 11; the rotary elements 48 rotate through 90° and make the third panel 11c fall towards the storage surface and position it above the first panel 11a.

The subsequent step, shown in FIG. 10, provides that the chain 36 engages with the panel 11d, the pivoting board 27 is lowered, a fifth panel 11e is introduced, and the second panel 11b is positioned on the accumulation plane 13.

FIG. 11 shows the subsequent step, which is almost identical to that shown in FIG. 8. In fact, the cycle of storage and discharge is repeated from this step, and provides the succession of steps shown in FIGS. 9, 10 and 11.

The entire cycle to form a pack of superimposed panels 11 lasts about 8 seconds, that is, every panel 11 needs about 4 seconds to be positioned straight or overturned on the accumulation plane 13 and then discharged. In this way, the waiting times are practically eliminated.

Modifications and/or additions of parts may be made to the device 10 as described heretofore, without departing from the field and scope of the present invention.

For example, the overturned panel 11a can be temporarily arranged on auxiliary positioning and discharge means, arranged above the rotary elements 48, on which the straight panel 11c is positioned. With every cycle the overturned panel is taken above the straight panel and discharged thereon and, in a subsequent step, the pack of two panels is discharged onto the underlying storage surface.

In another solution, the chains can be replaced by shaped belts, tracks or any other equivalent means having a similar or equivalent function.

1. Device for the automatic formation of packs of panels of electro-welded mesh, arranged downstream of a production machine comprising a work plane, the device comprising:
expulsion means able to arrange said panels emerging from said machine onto an accumulation plane located as an extension to the work plane of said machine,
turnover means able to turn over every other of said panels with respect to the position in which said every other of said panels exits said machine,
discharge means to discharge said panels, and
switching means arranged downstream of said expulsion means and able to direct, alternately and substantially continuously, at least one of said panels either directly towards said accumulation plane or towards said turnover means.

2. Device as in claim 1, wherein said turnover means comprise guide means conformed se as to rotate said panels sent towards them substantially through 180° and to position them overturned with respect to said accumulation plane.

3. Device as in claim 2, wherein said guide means comprise at least a first inclined rectilinear segment and at least a second curved segment able to connect said first rectilinear segment with said accumulation plane.

4. Device as in claim 3, wherein said second curved segment defines an angle of about 180°.

5. Device as in claim 2, wherein said turnover means comprise conveyor means able to transport said panels at least along said first segment and part of said second segment.

6. Device as in claim 5, wherein said conveyor means comprise at least a chain.

7. Device as in claim 5, wherein said conveyor means comprise a shaped belt.

8. Device as in claim 2 inclusive, wherein, in an initial zone of said first segment, said turnover means comprise attachment means able to prevent said panels from turning towards said expulsion means.

9. Device as in claim 2, wherein said turnover means comprise second expulsion means arranged in a terminal zone of said second segment and able to take said panels towards said accumulation plane.

10. Device as in claim 1, wherein said switching means comprise at least a board movable between a first position wherein said board directs said panel directly towards said accumulation plane and a second position wherein it directs said panel towards said turnover means.

11. Device as in claim 1, wherein said expulsion means are arranged downstream of the machine which produces said panels and comprise a frame on which are mounted rollers arranged on opposite sides with respect to a plane of feed on which said panels are able to advance.

12. Device as in claim 11, wherein at least one of said rollers is movable by means of actuator means between an inactive position wherein said at least one of said rollers is relatively distant from said plane of feed, and an active position wherein wherein said at least one of said rollers is in contact with at least one of said panels passing on said plane of feed.

13. Device as in claim 1, wherein said
discharge means comprise at least two rotary elements each one having a blade conformation, and able to selectively rotate around its own median axis to cause the fall and discharge of said panels.

14. Device as in claim 13, wherein said discharge means are arranged in correspondence with said accumulation plane.

15. Device as in claim 1, wherein said turnover means are arranged above said accumulation plane.

16. Device as in claim 1, comprising auxiliary guide means arranged at outlet from said turnover means, and able to temporarily retain at least a first overturned panel above said accumulation plane in order to allow a second straight panel to be positioned superimposed.

17. Method for the automatic formation of packs of panels of electro-welded mesh, comprising:
positioning at least one panel on an accumulation plane arranged as a substantial extension of the work plane of a machine which produces the panels,
turning over by means of turnover means at least every other one of said panels with respect to the position in which said at least every other one of said panels exits said machine in order to arrange said at least every other one of said panels overturned above said accumulation plane, and
discharge discharging said panels, wherein at least every other panel is alternately directed, by means of switching means, either directly towards said accumulation plane or towards said turnover means, to render substantially simultaneous said first positioning step to position a first panel on said accumulation plane and said second turnover step to overturn a second panel.

18. Method as in claim 17, wherein at the start of the cycle, at least two panels are arranged in cooperation with said turnover means before sending a third panel towards said accumulation plane in order to constitute an accumulation supply in said turnover means comprising at least one panel.

19. Method as in claim 17, wherein each of said panels takes about 4 seconds to be positioned on said accumulation plane and then discharged.

20. Method as in any claim from 17, wherein an overturned panel is positioned on guide means arranged above said accumulation plane, and said overturned panel is then discharged on a subsequent straight panel arranged on said accumulation plane in order to allow the simultaneous discharge of a pack of two panels.
